(19) United States
(12) Patent Application Publication
(10) Pub. No.: US 2012/0291717 A1
(43) Pub. Date: Nov. 22, 2012

(54) ADHESIVE PLIABLE NODULES FOR PET GROOMING AND SYSTEM AND METHODS OF USING SAME

(76) Inventors: Josh Rifkin, Solana Beach, CA (US); Ashley Palmer, Solana Beach, CA (US)

(21) Appl. No.: 13/302,058

(22) Filed: Nov. 22, 2011

Related U.S. Application Data
(60) Provisional application No. 61/458,367, filed on Nov. 23, 2010.
(60) Provisional application No. 61/435,158, filed on Jan. 21, 2011.

(51) Int. Cl. A01K 13/00; B32B 37/12

(52) U.S. Cl. 119/600; 156/247

(57) ABSTRACT

The present invention is a pliable adhesive pad with rubber protrusions or nodules for grooming and messaging pets, which optionally may be cut into different shapes and sizes for adherence to different surfaces. Alternatively, the present invention is specially pre-cut for application to a throwing apparatus. Specifically, the throwing apparatus is a ball launcher dog toy.

### PRIORITY INFORMATION

This application claims the benefit of priority under 35 U.S.C. §119(e) from U.S. Provisional Patent Application No. 61/458,367, filed Nov. 23, 2010, and U.S. Provisional Patent Application No. 61/435,158, filed Jan. 21, 2011, the entire contents of which are herein incorporated by reference.

### FIELD OF THE INVENTION

The present invention is a pliable adhesive pad with rubber protrusions or nodules for grooming and messaging pets, which optionally may be cut into different shapes and sizes for adherence to different surfaces. Alternatively, the present invention is specially pre-cut for application to a throwing apparatus. Specifically, the throwing apparatus is a ball launcher dog toy.

### BACKGROUND OF THE INVENTION

Grooming products for pets are present in the prior art. Rubber bristle grooming brushes are available in a variety of shapes, sizes and bristle/nodule rigidities. Brushes with rubber bristles may be in the shape of traditional grooming brushes, such as Hartz® Groomer's Best® Rubber Dog Brush. Alternatively, brushes may be modeled after the curry brush used in horse grooming. Curry brushes pull out dead hair and stimulate the skin, while removing flakes of dead skin and encouraging healthy blood flow near the skin. The gentlest form of a curry brush is made from rubber or a rubberized material. The rubber is highly flexible, allowing the comb to bend with the animal's body. The teeth take the form of gentle rubber nubbins, which will slowly wear down over use. As a result, the brush acts like a massager during grooming.

Pet grooming and massage gloves are available from a variety of manufacturers and are meant to accomplish the act of grooming and/or massaging an animal while the human engages in the activity of petting the animal. Generally, these are shaped like a traditional glove with soft, rubber tips attached to the palm of the glove.

The Scratch 'n All® grooming pad is a stationary, self-scratching pad made from silicon rubber that can be mounted on any flat, solid surface with the included mounting screws and washers. A similar product is made from highly flexible rubber such that it can be wrapped around fence posts and protruding objects.

In light of the above, it is an object of the present invention to provide the desired features described herein as well as additional advantages such as being pliable, more versatile than traditional grooming pads because screws, nails and/or mounting hardware is not required and being pre-cut to specifically adhere to the body of a throwing apparatus. Preferably, the throwing apparatus is similar in form to a Chuckit!® dog toy. Alternatively, the present invention may be cut into different shapes and sizes making it suitable for adherence to pet toys of all shapes and sizes. Another object of the present invention is to reduce a pet's anxiety about being groomed because the grooming pad is adhered to one of the pet's toys to which the pet is accustomed.

The invention can be better visualized by turning now to the following drawings wherein like elements are referenced by like numerals.

### SUMMARY OF THE INVENTION

The present invention provides a grooming pad made of a soft, flexible rubber material, such as pliable, resilient natural rubber. Natural rubber is durable enough to withstand being chewed on by an animal, for example a dog, while still being flexible enough to contour to an animal's skin and hair during grooming and/or massaging. The grooming pad may further have a tensile strength of about 2900 psi. In addition to durability, natural rubber protrusions or nodules are soft enough to avoid injury to animals when chewed but strong enough for use as a brush or massager. However, the protrusions or nodules may be made of any pliable material that is resilient and capable of withstanding being chewed on by an animal without causing injury to the animal or losing its desired utility. Such additional pliable, yet resilient materials include pliant plastic materials and nylon. Additionally, the grooming pad may be resistant to water. It is an object of the present invention to overcome or at least alleviate one or more of the difficulties or deficiencies related to the prior art.

In a first aspect, the present invention provides a grooming pad where the protrusions or nodules are uniform in size and shape. These protrusions or nodules may be available in a range of sizes from ¼-¾ inch in diameter. Alternatively, the protrusions or nodules may be irregular in size and shape, for example, the protrusions or nodules may alternate being ¼ inch and ½ inch in diameter, to create a more textured grooming and massaging surface. Further, the protrusions or nodules may be ¼ inch and ½ inch in diameter and arranged randomly on the grooming pad resulting in a significantly textured grooming and massaging surface.

In a second aspect, the present invention provides a grooming pad with an adhesive layer on the bottom surface of the grooming pad. The adhesive layer may be comprised of any substance or material that binds two objects together. Alternatively, the adhesive layer may be a pressure sensitive adhesive (PSA) such that the adhesive layer will form a bond by the application of light pressure to marry the adhesive to the object to be adhered. PSA's are also known as self-adhesive or self-stick adhesive. PSA's are commonly used on masking tape, note papers, pricing labels and athletic tape. PSA's are activated solely using the appropriate amount of pressure and without the need for solvents, water or heat. Additionally, the adhesive layer may be comprised of natural rubber based adhesive or synthetic rubber based adhesive and may form a permanent bond with the object to be adhered or a removable bond with the object to be adhered. A permanent bond is desired when the grooming pad is adhered to an object that does not lose utility once the grooming pad is adhered to it, i.e. a fence post or the opening of a doggie door. A removable bond is desired when the grooming pad is adhered to an object which the user wishes to only temporarily alter in order to groom or massage an animal, i.e. a favorite pet toy which may be returned to its original state once grooming or massaging is finished. Lastly, the adhesive layer may be covered with a protective backing until the protective backing is removed by the user to expose the adhesive layer.

In a third aspect, the present invention provides the grooming pad that is rectangular in shape such that the pad can be cut into different sizes and shapes and adhered to various surfaces and objects. The protective backing which covers the adhesive layer may have markings which reflect suggested patterns illustrating how to cut the grooming pad in order to adapt the grooming pad shape for adherence to certain surfaces. Alternatively, the grooming pad may be pre-cut into shapes such that the pad is readily adhered to various surfaces and objects. A pre-cut shape is desired when the grooming pad is to be adhered to a specific object such as a throwing apparatus. Preferably the throwing apparatus is similar in form to a Chuckit!® dog toy.

In a fourth aspect, the present invention provides a method for adhering a grooming pad to a pet toy or object comprising the steps of: a) providing a grooming pad cut to the specifications of a particular pet toy or object; b) removing the protective backing on the bottom surface of the grooming pad to expose the adhesive layer; c) adhering the grooming pad to the pet toy or object by the adhesive layer in such a manner as to maintain the utility of the original pet toy or object; and d) using the pet toy or object to groom or massage an animal. Additionally, the present invention provides a method for reducing the anxiety associated with grooming and massaging animals comprising adhering a grooming pad to an animal's favorite pet toy or at least an object sufficiently familiar to the animal.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a top perspective view of the grooming pad.

FIG. 2 illustrates a side perspective view of the grooming pad.

FIG. 3 illustrates a bottom perspective view of the grooming pad.

FIG. 4 illustrates an enlarged side perspective view of the grooming pad.

FIG. 5 illustrates an enlarged side perspective view of the grooming pad.

FIG. 6 illustrates the grooming pad adhered to a throwing apparatus in a form substantially similar to a Chuckit!® dog toy.

### DETAILED DESCRIPTION OF THE INVENTION

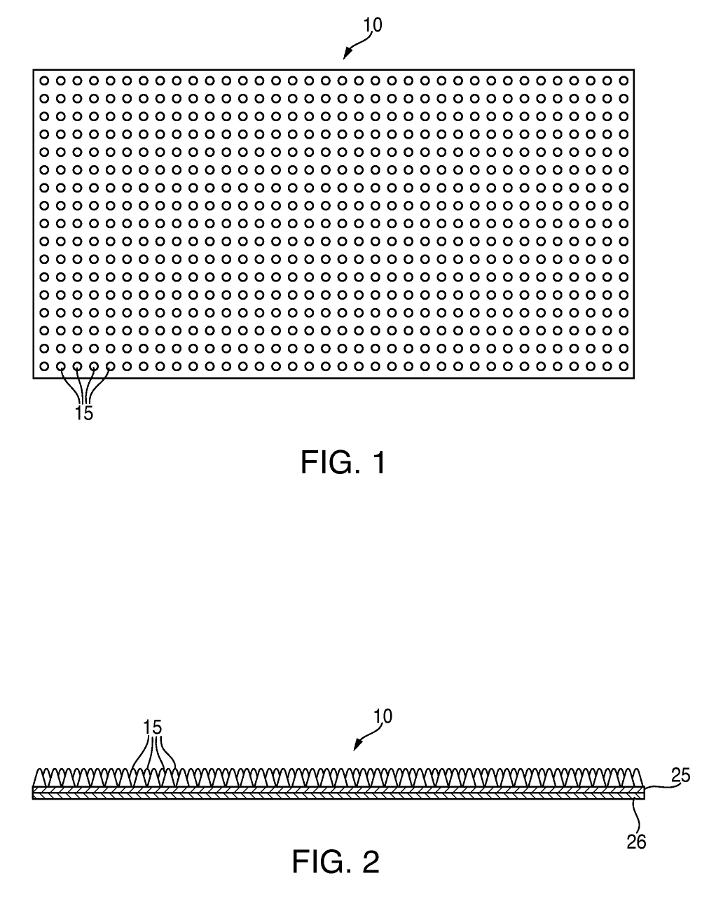

A grooming pad 10 is illustrated in a flat configuration in FIG. 1. On the surface of the grooming pad 10 are a plurality of protrusions or nodules 15 that extend outwardly.

A grooming pad 10 is illustrated in a side perspective view in FIG. 2. The protrusions or nodules 15 are seen extending outwardly from the surface of the grooming pad 10. On the side of the grooming pad 10 opposite the protrusions or nodules 15 is an adhesive layer 25. The adhesive layer 25 is covered by a protective backing 26, until it is peeled off by the user.

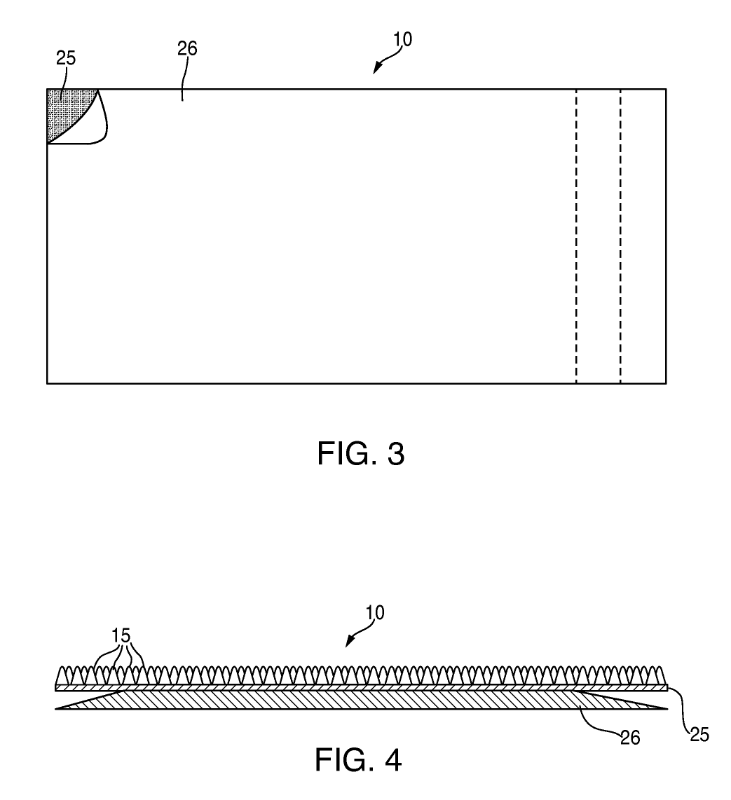

A grooming pad 10 is illustrated in a bottom perspective view in FIG. 3. The grooming pad 10 has a protective backing 26 that is peeled off to reveal the adhesive layer 25.

A grooming pad 10 is illustrated in an enlarged side perspective view in FIG. 4. The grooming pad 10 has a plurality of protrusions or nodules 15 on the top surface and an adhesive layer 25 covered by a protective backing 26 on the bottom surface.

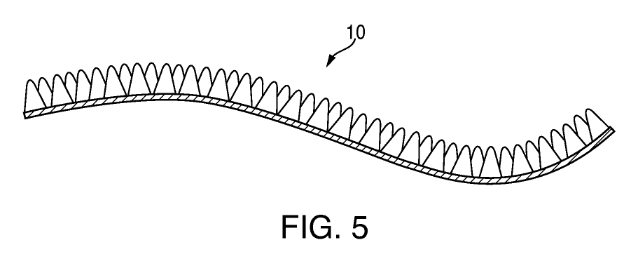

A grooming pad 10 is illustrated in an enlarged side perspective view in FIG. 5. The pliable nature of the grooming pad 10 is represented such that the grooming pad 10 may contour to the shape of virtually any pet toy or desired surface.

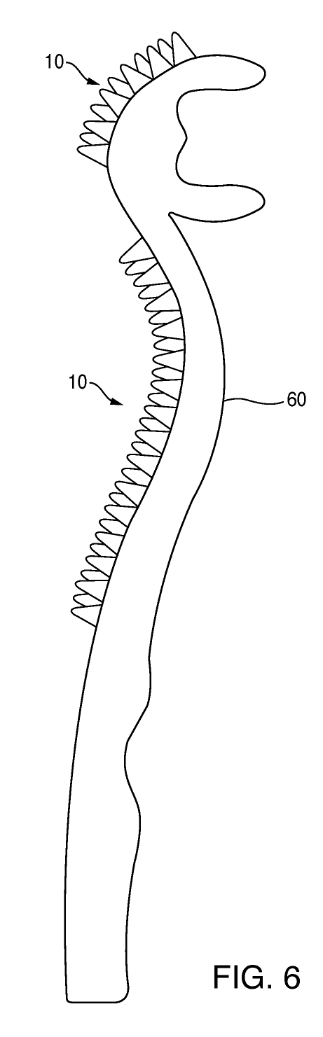

A grooming pad 10 is illustrated as adhered to a throwing apparatus 60 in FIG. 6. Preferably, the throwing apparatus is in a form substantially similar to a Chuckit!® dog toy. Alternatively, the throwing apparatus may contain the bristles in a unified mold.

One embodiment of the present invention provides for a grooming pad made of a soft, flexible rubber material. In a preferred embodiment, the grooming pad is made of pliable, resilient natural rubber because natural rubber is durable enough to withstand being chewed on by an animal, for example a dog, while still being flexible enough to contour to an animal's skin and hair during grooming and/or massaging. The preferred embodiment may further have a tensile strength of about 2900 psi. In addition to durability, natural rubber protrusions or nodules are soft enough to avoid injury to animals when chewed but strong enough for use as a brush or massager.

Another embodiment of the present invention provides for a grooming pad with protrusions or nodules made of any pliable material that is resilient and capable of withstanding being chewed on by an animal without causing injury to the animal or losing its desired utility. Such additional pliable, yet resilient materials include pliant plastic materials and nylon.

Another embodiment of the present invention provides for a grooming pad where the protrusions or nodules are uniform in size and shape. These protrusions or nodules may be available in a range of sizes from ¼-¾ inch in diameter. In a preferred embodiment, the protrusions or nodules are between ¼-½ inch in diameter.

In another embodiment of the present invention, the protrusions or nodules may be irregular in size and shape. In a preferred embodiment, the protrusions or nodules may alternate being ¼ inch and ½ inch in diameter, to create a more textured grooming and massaging surface. Alternatively, the protrusions or nodules may be ½ inch and ½ inch in diameter and arranged randomly on the grooming pad resulting in a significantly textured grooming and massaging surface.

In another embodiment of the present invention, the grooming pad may be resistant to water.

In another embodiment of the present invention, the adhesive layer on the bottom surface of the grooming pad may be comprised of any substance or material that binds two objects together.

In another embodiment of the present invention, the adhesive layer may be a pressure sensitive adhesive (PSA) such that the adhesive layer will form a bond by the application of light pressure to marry the adhesive to the object to be adhered. PSA's are also known as self-adhesive or self-stick adhesive. PSA's are commonly used on masking tape, note papers, pricing labels and athletic tape. PSA's are activated solely using the appropriate amount of pressure and without the need for solvents, water or heat.

In another embodiment of the present invention, the adhesive layer may be comprised of natural rubber based adhesive.

In another embodiment of the present invention, the adhesive layer may be comprised of synthetic rubber based adhesive.

In another embodiment of the present invention, the adhesive layer may form a permanent bond with the object to be adhered. A permanent bond is desired when the grooming pad is adhered to an object that does not lose utility once the grooming pad is adhered to it, i.e. a fence post or the opening of a doggie door.

In another embodiment of the present invention, the adhesive layer my form a removable bond with the object to be adhered. A removable bond is desired when the grooming pad is adhered to an object which the user wishes to only temporarily alter in order to groom or massage an animal, i.e. a favorite pet toy which may be returned to its original state once grooming or massaging is finished.

In another embodiment of the present invention, the grooming pad may be rectangular in shape such that the pad can be cut into different sizes and shapes and adhered to various surfaces and objects.

In another embodiment of the present invention, the protective backing which covers the adhesive layer may have markings which reflect suggested patterns illustrating how to cut the grooming pad in order to adapt the grooming pad shape for adherence to certain surfaces.

In another embodiment of the present invention, the grooming pad may be pre-cut into shapes such that the pad is readily adhered to various surfaces and objects. A pre-cut shape is desired when the grooming pad is to be adhered to a specific object such as a throwing apparatus. Preferably the throwing apparatus is similar in form to a Chuckit!® dog toy.

Another embodiment of the present invention provides a method for adhering a grooming pad to a pet toy or object comprising the steps of: a) providing a grooming pad cut to the specifications of a particular pet toy or object; b) removing the protective backing on the bottom surface of the grooming pad to expose the adhesive layer; c) adhering the grooming pad to the pet toy or object by the adhesive layer in such a manner as to maintain the utility of the original pet toy or object; and d) using the pet toy or object to groom or massage an animal.

A further embodiment of the present invention provides a method for reducing the anxiety associated with grooming and massaging animals comprising adhering a grooming pad to an animal's favorite pet toy or at least an object sufficiently familiar to the animal.

It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

We claim:

1. A grooming pad for grooming and/or massaging pets comprising a soft, flexible pad with a plurality of protrusions or nodules extending outwardly from the top surface of the grooming pad.

2. The grooming pad of claim 1, wherein the grooming pad is made of a pliable rubber material.

3. The grooming pad of claim 1, wherein the bottom surface of the grooming pad is comprised of an adhesive layer for securing the grooming pad to a surface or object.

4. The grooming pad of claim 3, wherein the adhesive layer on the bottom surface of the grooming pad further comprises a protective backing which covers the adhesive layer until removed by the user to expose the adhesive layer.

5. The grooming pad of claim 1, wherein the plurality of protrusions or nodules are uniform in size and shape.

6. The grooming pad of claim 1, wherein the plurality of protrusions or nodules are irregular in size, shape and orientation.

7. The grooming pad of claim 1, wherein the grooming pad is water resistant.

8. The grooming pad of claim 3, wherein the adhesive layer is comprised of a substance or material that binds two objects together.

9. The grooming pad of claim 3, wherein the adhesive layer is comprised of a pressure sensitive adhesive.

10. The grooming pad of claim 3, wherein the adhesive layer is comprised of natural rubber based adhesive.

11. The grooming pad of claim 3, wherein the adhesive layer is comprised of synthetic rubber based adhesive.

12. The grooming pad of claim 3, wherein the adhesive layer is capable of forming a permanent bond with the object to be adhered.

13. The grooming pad of claim 3, wherein the adhesive layer is capable of forming a removable bond with the object to be adhered.

14. The grooming pad of claim 1, wherein the grooming pad is rectangular in shape such that the pad may be cut into different shapes and sizes by the user for adherence to various surfaces and objects.

15. The grooming pad of claim 1, wherein the grooming pad is pre-cut to various shapes and sizes such that the grooming pad may be readily adhered to various surfaces and objects.

16. The grooming pad of claim 4, wherein the protective backing contains markings which reflect suggested patterns illustrating how the user may cut the grooming pad in order to adapt the shape of the grooming pad for adherence to various surfaces and objects.

17. The grooming pad of claim 15, wherein the grooming pad is specially pre-cut for application to a throwing apparatus.

18. The grooming pad of claim 17, wherein the throwing apparatus is a ball launcher dog toy.

19. A method for adhering a grooming pad to a pet toy or object comprising the steps of:
a) providing a grooming pad cut to the specifications of a particular pet toy or object;
b) removing the protective backing from the bottom surface of the grooming pad to expose the adhesive layer; and
c) adhering the grooming pad to the pet toy or object by the adhesive layer in such a manner as to maintain the utility of the original pet toy or object.

20. A method for reducing the anxiety associated with grooming and massaging animals comprising the steps of:
a) adhering a grooming pad to an animal's favorite pet toy or at least an object sufficiently familiar to the animal; and
b) using the pet toy or object to groom or massage an animal.
